(19) United States
(12) Patent Application Publication
(10) Pub. No.: US 2026/0202859 A1
(43) Pub. Date: Jul. 16, 2026

(54) AUTOMATIC VELOCITY CONTROL SYSTEM FOR A TRANSPORTATION SYSTEM

(71) Applicant: Ryan LETCHER, Endicott, NY (US)

(72) Inventor: Ryan LETCHER, Endicott, NY (US)

(21) Appl. No.: 19/018,023

(22) Filed: Jan. 13, 2025

(51) Int. Cl. G05D 1/65; G05D 1/644

(52) U.S. Cl. CPC G05D 1/65; G05D 1/644

(57) ABSTRACT

In one or more aspects of the present disclose a velocity control device of a transportation that comprises a memory, storing one or more computer-readable instructions, and a processor, configured to execute the one or more computer-readable instructions. The velocity control device monitors one or more parameters associated with the transportation system, receives data associated with the one or more parameters from one or more sources, obtain a current velocity of the transportation system based on at least one of the one or more parameters, obtains a current acceleration associated with the transportation system based on at least one of the one or more parameters, and causes the transportation system to adjust the first acceleration to the second acceleration.

### BACKGROUND

Velocity control systems have become ubiquitous in transportation systems. Velocity control systems assist a transportation system with maintaining an approximately constant velocity. However, such velocity control systems fail to adequately predict impediments to maintaining the constant velocity. Thus, there is a need for an improved velocity control system so as to provide a constant velocity and significantly increase fuel efficiency, for example, up to twenty percent (20%) for a transportation system.

### SUMMARY

Generally, there are several velocity control systems in the market that provide an approximately constant velocity for a transportation system when activated. However, these velocity control systems have limited capabilities in that one or more transportation parameters associated with the velocity of the transportation are not utilized. To overcome such limitations, one or more novel aspects of the present invention utilize a plurality of transportation parameters associated with the transportation system to provide an improved automatic multi-parameter velocity control system. One or more novel aspects of the present invention utilize a plurality of transportation parameters to not only maintain a more accurate constant velocity but also provide increased fuel efficiency, improved performance, reduced of costs (for example, fuel costs), and increased reliability.

An aspect of the present disclosure provides a velocity control device of a transportation system. The velocity control device comprises a memory storing one or more computer-readable instructions and a processor configured to execute the one or more computer-readable instructions to monitor one or more parameters associated with the transportation system, receive data associated with the one or more parameters from one or more sources, obtain a current velocity of the transportation system based on at least one of the one or more parameters, obtain a current acceleration associated with the transportation system based on at least one of the one or more parameters, obtain a projected acceleration associated with the transportation system based on additional one or more parameters, and cause the transportation system to adjust the first acceleration to the second acceleration.

In an aspect of the present disclosure, the projected acceleration is further based on one or more velocity targets.

In an aspect of the present disclosure, the projected acceleration is an increase over the current acceleration.

In an aspect of the present disclosure, the processor is further configured to execute the one or more instructions to cause the transportation system to temporarily alter fuel consumption to adjust to the projected acceleration.

In an aspect of the present disclosure, the one or more sources comprise any of an accelerometer, a compass, a global positioning system device.

In an aspect of the present disclosure, the one or more parameters comprise any of a global position system data, a topography data, an acceleration data, a geographical data or any combination thereof.

In an aspect of the present disclosure, the processor is further configured to execute the one or more instructions to update a display device of the transportation system based on the projected acceleration.

An aspect of the present disclosure provides a method of a velocity control device to maintain a velocity of a transportation system. The method comprises monitoring one or more parameters associated with the transportation system, receiving data associated with the one or more parameters from one or more sources, obtaining a current velocity of the transportation system based on at least one of the one or more parameters, obtaining a current acceleration associated with the transportation system based on at least one of the one or more parameters, obtaining a projected acceleration associated with the transportation system based on additional one or more parameters, and causing the transportation system to adjust the first acceleration to the second acceleration.

In an aspect of the present disclosure, the method such that the projected acceleration is further based on one or more velocity targets.

In an aspect of the present disclosure, the method such that the projected acceleration is an increase over the current acceleration.

In an aspect of the present disclosure, the method further comprising causing the transportation system to alter fuel consumption to adjust to the projected acceleration.

In an aspect of the present disclosure, the method such that the one or more sources comprise any of an accelerometer, a compass, a global positioning system device.

In an aspect of the present disclosure, the method such that the one or more parameters comprise any of a global position system data, a topography data, an acceleration data, a geographical data or any combination thereof.

In an aspect of the present disclosure, the method further comprising updating a display device of the transportation system based on the projected acceleration.

An aspect of the present disclosure provides a non-transitory computer-readable medium of a velocity control device of a transportation system, the non-transitory computer-readable medium storing one or more instructions. The one or more instructions when executed by a processor of the velocity control device, cause the velocity control device to perform one or more operations including the steps of the methods described above.

Thus, according to various aspects of the present disclosure described herein, it is possible to provide an improved automatic multi-parameter velocity control device of a velocity control system for adjusting certain parameters so as to alter an acceleration so as to maintain a velocity of a transportation system to provide fuel efficiency, for example, by as much as 15-20%.

### BRIEF DESCRIPTION OF DRAWINGS

In the drawings, like reference numbers generally indicate identical, functionally similar, and/or structurally similar elements.

FIG. 1 is a schematic diagram of an velocity control environment associated with a velocity control device of a velocity control system of a transportation system, according to one or more aspects of the present disclosure;

FIG. 2 is a more detailed block diagram illustrating various components of an exemplary velocity control device, according to one or more aspects of the present disclosure;

FIG. 3 is an illustration of a velocity control environment for communication between a velocity control device of a transportation system and an information handling system (server), according to one or more aspects of the present disclosure; and

FIG. 4 is a flow chart illustrating a method of a velocity control device for maintaining a velocity of a transportation system, according to one or more aspects of the present disclosure.

### DETAILED DESCRIPTION

The following detailed description is made with reference to the accompanying drawings and is provided to assist in a comprehensive understanding of various example embodiments of the present disclosure. The following description includes various details to assist in that understanding, but these are to be regarded merely as examples and not for the purpose of limiting the present disclosure as defined by the appended claims and their equivalents. The words and phrases used in the following description are merely used to enable a clear and consistent understanding of the present disclosure. In addition, descriptions of well-known structures, functions, and configurations may have been omitted for clarity and conciseness. Those of ordinary skill in the art will recognize that various changes and modifications of the examples described herein can be made without departing from the spirit and scope of the present disclosure.

A velocity control device to maintain, control or otherwise manage a velocity of a transportation system provides benefits over present systems, such as cruise control systems. For example, a velocity control device can utilize specific parameters to anticipate an acceleration (such as an increase or decrease in acceleration) required, for example, by at least three or more seconds. Such anticipation can reduce consumption of resources, such as fuel consumption, and improve user experience by anticipating or otherwise obtaining one or more parameters associated with the transportation system. The one or more parameters can comprise a location, one or more topographic characteristics (including, but not limited to, any of relief, slope, elevation (for example, a height above or below a predetermined reference point, a surface, and/or a ground point such as sea level, an altitude, or any combination thereof), any other topographical characteristic, or any combination thereof), one or more environmental conditions (such as any of rain, snow, sleet, temperature, any other weather and/or ecological conditions, or any combination thereof), any other geographical characteristic, or any combination thereof. The velocity control device utilizes the one or more parameters to determine a control for maintaining, increasing, or otherwise altering velocity of the transportation system. In this way, the velocity control device utilizes information to meet thresholds associated with the consumption of resources to provide the user with an improved experience.

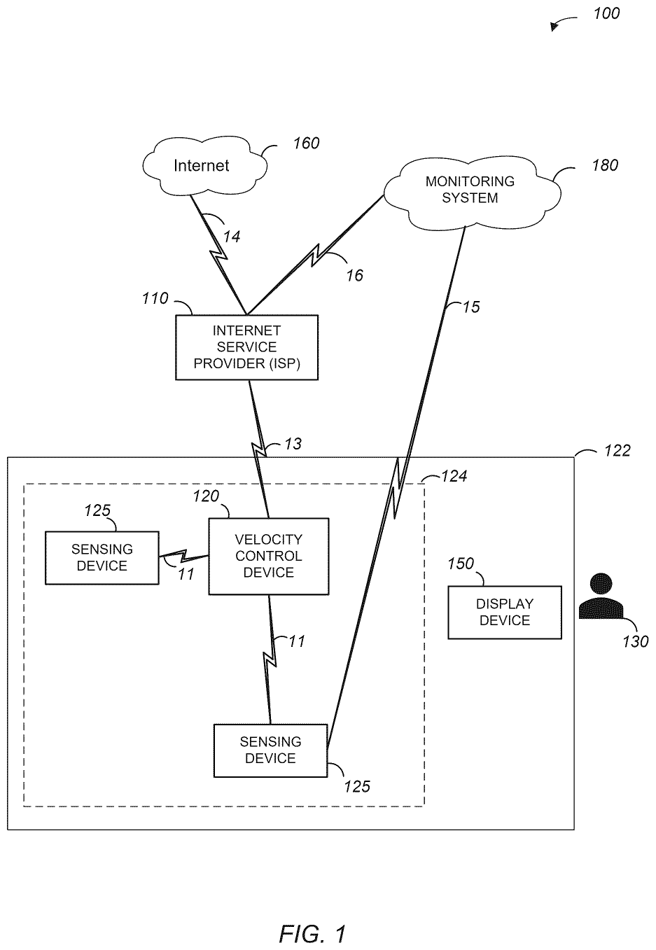

FIG. 1 is a schematic diagram of a velocity control environment 100 associated with a velocity control device 120 of a velocity control system 124 of a transportation system 122, according to one or more aspects of the present disclosure. It should be appreciated that various example embodiments of inventive concepts disclosed herein are not limited to specific numbers or combinations of devices, and there may be one or multiple of some of the aforementioned electronic apparatuses in the network environment, which may itself consist of multiple communication networks and various known or future developed wireless connectivity technologies, protocols, devices, and the like.

The velocity control environment 100 can comprise a transportation system 122 connected to a network resource such as any of the Internet 160, a monitoring system 180, any other cloud storage/repository, or any combination thereof via an Internet Service Provider (ISP) 110. The transportation system 122 can comprise a vehicle (for example, an automobile, an autonomous vehicle, an electric vehicle (EV), an aircraft, a drone, any other motorized vehicle, any other vehicle for transportation (such as transportation of any of a person, one or more goods, livestock, any other material, or any combination thereof), or any combination thereof). In one or more embodiments, the transportation system 122 comprises any of a velocity control system 124, a display device 150, one or more sensing devices 125, or any combination thereof. The transportation system 122 can be associated with a user 130, for example, a driver or controller of the transportation system 122. The user 130 can be local to or remote from the transportation system 122. For example, the user 130 can be a computer system, a person, or both that provides steering or makes decisions related to the operation, control and/or management of the transportation system 122.

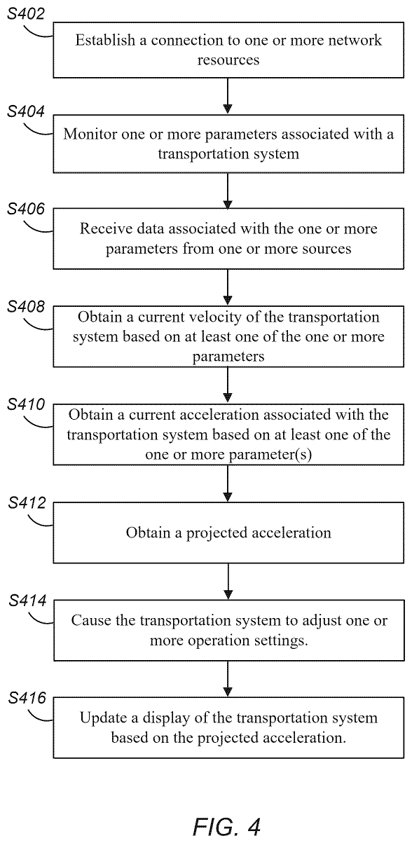

The velocity control system 124 of the transportation system 122 can comprise one or more network devices such as a velocity control device 120 and one or more sensing devices 125. The velocity control device 120 and the one or more sensing devices 125 may be connected in one or more wireless networks (for example, private, guest, iControl, backhaul network, or Internet of things (IOT) network) and/or wired networks within the velocity control environment 100. The display device 150 can display information to the user 130, for example, as discussed with reference to FIG. 1 and FIG. 4.

The ISP 110 can be, for example, a content provider or any computing system for connecting the velocity control device 120 to a network resource, such as Internet 160, monitoring system 180. For example, Internet 160 can be a cloud-based service that provides access to a cloud-based repository accessible via ISP 110 where the cloud-based repository comprises information associated with one or more parameters associated with the velocity control system 124 of the velocity control environment 100. The monitoring system 180 can provide monitoring, aggregation and/or controlling of information associated with a user 130 of the velocity control device 120 in the network environment 100, such as data collected by one or more sensing devices 125. In one or more embodiments, the monitoring system 180 can communicate with any one or more external repositories of Internet 160 via ISP 110 or internal repositories. The monitoring system 180 can comprise one or more application programming interfaces (API) that provide for obtaining any of the one or more parameters. In one or more embodiments, any of the sensing devices 5 can be directly or indirectly coupled to the monitoring system 1800 and/or any other network device. The connection 14 between the Internet 160 and the ISP 110, the connection 11 between the velocity control device and one or more sensing devices 125, the connection 16 between the monitoring system 180 and the ISP 110, the connection 15 between the monitoring system 180 and a sensing device 125, and the connection 13 between the ISP 110 and the velocity control device 120 can be implemented using a wide area network (WAN), a virtual private network (VPN), metropolitan area networks (MANs), system area networks (SANs), a data over cable service interface specification (DOCSIS) network, a fiber optics network (e.g., FTTH (fiber to the home) or FTTX (fiber to the x), or hybrid fiber-coaxial (HFC)), a digital subscriber line (DSL), a public switched data network (PSDN), a global Telex network, or a 2G, 3G, 4G, 5G, 6G network, and/or any other network, for example. In one or more embodiments, the velocity control device 120 can be connected directly to monitoring system 180, for example, via a connection similar to or the same as connection 15, indirectly, for example as illustrated, or both.

Any of the connections 11, 13, 14, 15, 16, or any combination thereof (collectively referred to as network connections or connections) can further include as some portion thereof a broadband mobile phone network connection, an optical network connection, or other similar connections. For example, any of the network connections can also be implemented using a fixed wireless connection that operates in accordance with, but is not limited to, 3rd Generation Partnership Project (3GPP) Long Term Evolution (LTE), 5G, or 6G protocols. It is also contemplated by the present disclosure that any of the network connections are capable of providing connections between a network device and a WAN, a LAN, a VPN, MANs, PANs, WLANs, SANs, a DOCSIS network, a fiber optics network (e.g., FTTH, FTTX, or HFC), a PSDN, a global Telex network, or a 2G, 3G, 4G, 5G, 6G network, and/or any other network, for example.

The transportation system 122 can be any motorized element capable of a velocity that moves people, goods, animals, etc. from one place to another via any of air, land, sea, cable, any other mode of transportation, or any combination thereof. For example, a transportation system 122 can be any of a train, a vehicle, a truck, a railcar, any other element used for transport, or any combination thereof. The transportation system 122 can comprise a velocity control system 124. The velocity control system 124 of the transportations system 122 can comprise a velocity control device 120 and one or more sensing devices 125. The velocity control device 120 can be, for example, an electronic device, such as a computer system, that can comprise any of one or more elements, devices, circuitry, any other electronics, or any combination thereof for receiving one or more parameters from the monitoring system 180, the one or more sensing devices 125, or both for controlling, managing, and/or maintaining a velocity of a transportation system 122. In one or more embodiments, one or more network resources, such as monitoring system 180, the one or more sensing devices 125 are local to or within the velocity control device 2. In one or more embodiments, the one or more sensing devices 125, the monitoring system 180, or both can be directly or indirectly connected to the velocity control device 2.

The connection 11 between the velocity control device 120 and the one or more sensing devices 125 can be implemented through a wireless connection that operates in accordance with any IEEE 802.11 Wi-Fi protocols, Bluetooth protocols, BLE, or other short range protocols that operate in accordance with a wireless technology standard for exchanging data over short distances using any licensed or unlicensed band such as the CBRS band, 2.4 GHz bands, 5 GHz bands, 6 GHz bands, or 60 GHz bands or a direction connection, such as via a cable or other physical connection. Additionally, the connection 11 can be implemented using a wireless connection that operates in accordance with, but is not limited to, RF4CE protocol, ZigBee protocol, Z-Wave protocol, or IEEE 802.15.4 protocol.

Any of the one or more sensing devices 125 can comprise or be coupled to a global positioning system (GPS), an accelerometer and/or any sensor for providing information associated with speed, velocity or both (such as any of microwave sensor, fiber optic sensor, laser sensor, any other velocity and/or speed sensor, or any combination thereof), a wheel speed sensor, an anti-lock braking system (ABS) sensor, a compass, a pressure sensor, a barometric pressure sensor and/or any other sensor that can provide information associated with altitude, elevation, or both such as an altimeter meter and/or a laser measurement sensor, an optical instrument (such as a camera, an image capture device, any other visual user interface device, any device for capturing an image, a video, a multi-media video, or any other type of data, or a combination thereof), ambient temperature sensor, a light sensor, a humidity sensor, a motion detector (such as, an infrared motion sensor or Wi-Fi motion sensor), a facial recognition system, a temperature sensor, a voice recognition system, a microphone (such as, a far field voice (FFV) microphone) or other voice capture system, any other sensing device, or a combination thereof. In one or more embodiments, any one or more sensing devices 125 can be implemented by one or more network resources such as monitoring system 180.

It is contemplated by the present disclosure that the monitoring system 180, the velocity control device 120, and the one or more sensing devices 125 comprise electronic components or electronic computing devices operable to receive, transmit, process, store, and/or manage data and information associated with the velocity control environment 100, which encompasses any suitable processing device adapted to perform computing tasks consistent with the execution of computer-readable instructions stored in a memory or a computer-readable recording medium (for example, a non-transitory computer-readable medium). Further, any, all, or some of the computing components in the monitoring system 180, the velocity control device 120, and the one or more sensing devices 125 may be adapted to execute any operating system, including Linux, UNIX, Windows, MacOS, DOS, and ChromOS as well as virtual machines adapted to virtualize execution of a particular operating system, including customized and proprietary operating systems. Any of the monitoring system 180, the velocity control device 120, and the one or more sensing devices 125, or any combination thereof are further equipped with components to facilitate communication with other computing devices or other network devices over the one or more network connections to local and wide area networks, wireless and wired networks, public and private networks, and any other communication network enabling communication in the velocity control environment 100.

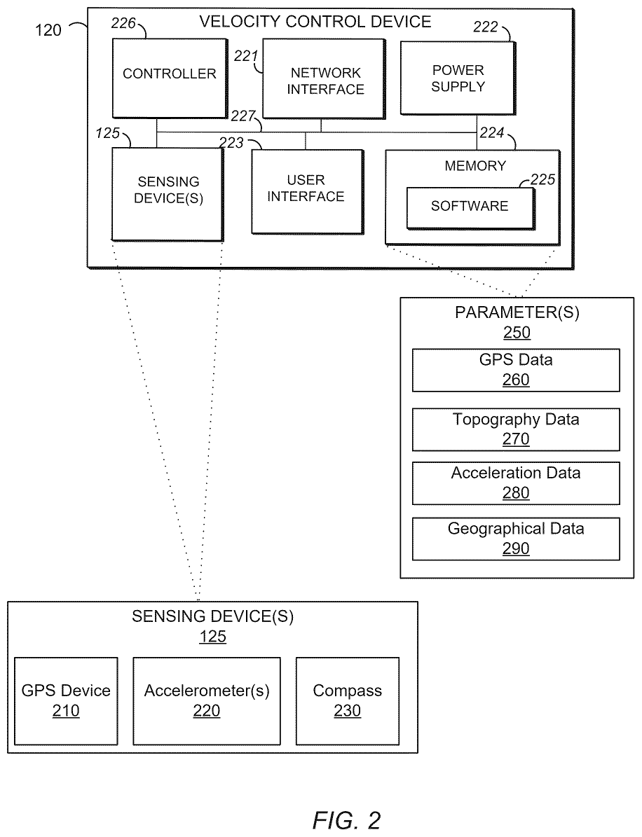

FIG. 2 is a more detailed block diagram illustrating various components of an exemplary velocity control device 120, according to one or more aspects of the present disclosure. The velocity control device 120 can be, for example, a computer, a server, any other computer device with smart capabilities capable of connecting to the Internet, cellular networks, and interconnecting with other network devices via Wi-Fi and Bluetooth, or other wireless hand-held consumer electronic device capable of providing management, receiving data and controlling data. The velocity control device 120 can comprise one or more internal components, such as a user interface 223, one or more sensing devices 125, a network interface 221, a power supply 222, a controller 226, a memory 224, and a bus 227 interconnecting the one or more elements.

The power supply 222 supplies power to the one or more internal components of the velocity control device 120 through the internal bus 227. The power supply 222 can be a self-contained power source such as a battery pack with an interface to be powered through an electrical charger connected to an outlet (e.g., either directly or by way of another device). The power supply 222 can also include a rechargeable battery that can be detached allowing for replacement such as a nickel-cadmium (NiCd), nickel metal hydride (NiMH), a lithium-ion (Li-ion), or a lithium Polymer (Li-pol) battery.

The user interface 223 includes, but is not limited to, push buttons, a keyboard, a keypad, a liquid crystal display (LCD), a thin film transistor (TFT), a light-emitting diode (LED), a high definition (HD) or other similar display device including a display device having touch screen capabilities so as to allow interaction between a user 130 and the velocity control device 120, for example, for a user 130 to enter data associated with any of operation of the velocity control device 120, current location of the transportation system 122, destination of the transportation system 122, or any combination thereof that are stored in memory 224. As an example, display device 150 can be part of or included within user interface 223. The network interface 221 can include, but is not limited to, various network cards, interfaces, and circuitry implemented in software and/or hardware to enable communications with and/or between the monitoring system 180, the one or more sensing devices 125, or both using any one or more of the communication protocols in accordance with any one or more connections (e.g., as described with reference to FIG. 1). In one or more embodiments, the user interface 223 and/or the network interface 221 enables communications with a sensing device 125, directly or indirectly. In one or more embodiments, the one or more sensing devices 125 are local to as illustrated or remote from the velocity control device 120 as illustrated in FIG. 1. The one or more sensing devices 125 can comprise any of a GPS device 210, one or more accelerometers 220, a compass 230, any other sensing device 125 related to or associated with the velocity control device 120, or any combination thereof. Any data received from the one or more sensing devices 125, such as any of one or more parameters 250, can be stored local to or remote from the velocity control device 120.

The memory 224 includes a single memory or one or more memories or memory locations that include, but are not limited to, a random access memory (RAM), a dynamic random access memory (DRAM) a memory buffer, a hard drive, a database, an erasable programmable read only memory (EPROM), an electrically erasable programmable read only memory (EEPROM), a read only memory (ROM), a flash memory, logic blocks of a field programmable gate array (FPGA), an optical storage system, a hard disk or any other various layers of memory hierarchy. The memory 224 can be used to store any type of instructions, software, or algorithms including software 225 for controlling the general function and operations of the velocity control device 120 in accordance with one or more embodiments. In one or more embodiments, memory 224 can store one or more parameters 250 associated with the controlling, maintaining or otherwise managing the velocity of the transportation system 122. The one or more parameters 250 can comprise any of one or more GPS data 260 (for example, data associated with any of a current position of the transportation system 122, a projected position of the transportation system 122, a route associated with the transportation system 122, any other position of the transportation system 122, or any combination thereof), topography data 270 (for example, any of a current elevation of the transportation system 122, a projected elevation of the transportation system 122, one or more elevation of a route associated with the transportation system 122, any other topographical information, or any combination thereof), acceleration data 280, geographical data 290, any other data or information associated with one or more sensing devices 125, monitoring system 180, one or more other network resources, or any combination thereof. In one or more embodiments, any of the one or more parameters 250 can be stored locally at the velocity control device 120, such as in memory 224, or remotely, such as at a network resource, for example, a monitoring system 180, one or more repositories, such as one or more databases, or both. In one or more embodiments, a flight path can be predetermined and programmed into the transportation system 122 such that any altitude changes are predetermined.

The controller 226 controls the general operations of the velocity control device 120 and includes, but is not limited to, a central processing unit (CPU), a hardware microprocessor, a hardware processor, a multi-core processor, a single core processor, a field programmable gate array (FPGA), a microcontroller, an application specific integrated circuit (ASIC), a digital signal processor (DSP), or other similar processing device capable of executing any type of instructions, algorithms, or software including the software 225 which can include a monitoring application in accordance with one or more embodiments. Communication between the components (for example, 221, 222, 223, 224, 226, and 5) of the velocity control device 120 may be established using an internal bus 227.

The network interface 221 can include various network cards, interfaces, and circuitry implemented in software and/or hardware to enable communications with any one or more other network devices, for example, any of a sensing device 125, ISP 110, any other network device (for example, as described with reference to FIG. 1), or any combination thereof. The network interface 221 can include multiple radios or sets of radios (for example, a 2.4 GHz radio, one or more 5 GHz radios, and/or a 6 GHz radio), which may also be referred to as wireless local area network (WLAN) interfaces. In one or more embodiments, the network interface 221 can comprise a wide area network (WAN) interface, a local area network (LAN) interface, or both.

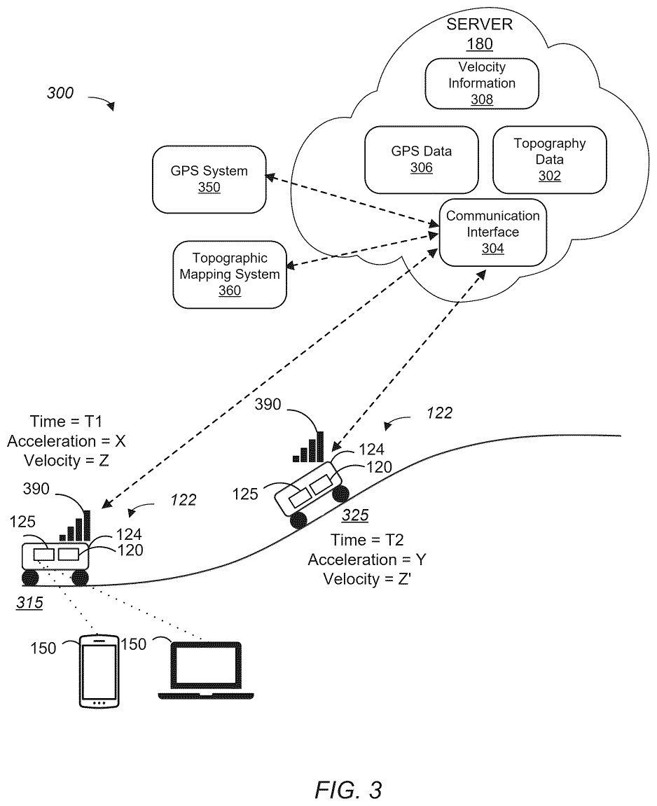

FIG. 3 is an illustration of a velocity control environment 300, similar to or the same as velocity control environment 100, for communication between a velocity control device 120 of a velocity control system 124 of a transportation system 122 and an information handling system (for example, a server such as monitoring system 180), according to one or more aspects of the present disclosure.

The monitoring system 180 can comprise one or more repositories for storing any of GPS data 306, topography data 302, velocity information 308 or any combination thereof. The monitoring system 180 can receive data from one or more sources, such as one or more sensing device 125, a GPS system 350 (for example, that provides GPS data 306), a topographic mapping system 360 (for example, that provides topographic data 302 such as from any of The United States Geographical Survey (USGS), Google Maps, any other mapping service, or any combination thereof) so that the monitoring system 180 can determine one or more parameters 250 associated with the transportation system 122. The monitoring system 180 can receive data from one or more sensing devices 125, for example, the data can comprise one or more parameters 250 or information associated with one or more parameters 250 such that the monitoring system 180 can determine velocity information 308 based on any of a current velocity, a projected velocity, a velocity range, a velocity threshold or any combination thereof and provide the velocity information 308 to the velocity control device 120 so as to maintain a velocity of the transportation system 122. In one or more embodiments, any of the monitoring system 180, any of the one or more sensing devices 125, or any combination thereof, provide one or more parameters 250 to the velocity control device 120 and the velocity control device 120 determines the velocity information 308 so as maintain a velocity any of a current velocity, a projected velocity, a velocity range, a velocity threshold or any combination thereof.

A communication interface of monitoring system 180 can send and receive data from any of one or more network resources (such as any of the GPS system 350, the topographic mapping system 360, any other network resources, or any combination thereof), the transportation system 122, one or more sensing devices 125, any other network resource, or any combination thereof. The monitoring system 180 can communicate with one or more repositories local to or remote from the monitoring system 180 including, but not limited to, one or more repositories that store velocity information 308, GPS data 306, topographic data 302, any other data, or any combination thereof. In one or more embodiments, the velocity control device 120 of transportation system 122 stores any of the one or more parameters 250, the velocity information, 308, the GPS data 306, the topographical data 302, any other data from one or more sensing devices 125, any other data associated with the transportation system 122, or any combination thereof.

As an example, a velocity control device 120 can be part of or within a transportation system 122. The velocity control device 120 can include or otherwise be communicatively coupled to one or more sensing devices 125. The velocity control device 120 can be in communication with the communication interface 304 of a monitoring system 180, for example, via a cellular network 390. At a time T1, the transportation system 122 can be at a first location 315, with an acceleration of X (a first acceleration) and a velocity of Z (a first velocity). For example, at time T1, the transportation system can have a first velocity of Z=65 miles per hour (mph) (at or about 104.61 kilometers per hour (kph)) with a fuel consumption of 35 miles per gallon (mpg) (at or about 14.88 kilometers per liter (km/l). The velocity control device 120 receives one or more parameters 250 that indicate that the terrain of the projected route is about to change from the monitoring system 180 via wireless network 390, for example. Based on the one or more parameters 250, the velocity control device 120 can determine an amount of an acceleration Y (a second acceleration) required at a time T2 (a second time) at a second location 325 to maintain a velocity Z′ (a second velocity) where Z′ indicates a velocity that is at or about a first velocity Z, for example, based on one or more velocity targets, such as any of a margin of error of the first velocity Z (for example, within a percentage of the first velocity Z), a velocity threshold (for example, any at, below, above, or any combination thereof of a velocity threshold), a velocity range (for example, within a first velocity to a second velocity), any other velocity targets, or any combination thereof. For example, the velocity control device 120 can receive a projected change in elevation at Time T2 (a second time) and based on the projected change in elevation acceleration of the transportation system 122 can be altered (such as any of changed, increased, decreased, adjusted, modified, or any combination thereof) from a first acceleration X to a second acceleration Y so as to maintain the transportation system at a velocity Z'. For example, to traverse uphill, the first acceleration X can be increased to a second acceleration Y and to traverse downhill, the first acceleration X can be decreased to a second acceleration Y.

FIG. 4 is a flow chart illustrating a method of a velocity control device 120 for maintaining a velocity of a transportation system 122, according to one or more aspects of the present disclosure. The velocity control device 120 comprises a processor 226 that executes one or more computer-readable instructions, stored on a memory 224, for example, software 225 stored in memory 224 to cause the velocity control device 120 to perform one or more of the operations of steps S402-S416. While the steps of FIG. 4 are presented in a certain order, the present disclosure contemplates that any one or more steps can be performed simultaneously, substantially simultaneously, repeatedly, in any order or not at all (omitted).

At step S402, the velocity control device 120 of a transportation system 122 establishes a connection with one or more network resources, such as a monitoring system 180 so as to receive data associated with the transportation system 122. For example, the velocity control device 120 can establish a wireless connection, such as a cellular network connection. The one or more network resources can be a repository, a database, an interface, such as an API, to one or more Internet sites and/or other applications that can provide any one or more of the one or more parameters 250, such as a GPS system 350, a topographic mapping system 360, or both.

At step S404, the velocity control device 120 monitors one or more velocity parameters associated with a velocity of the transportation system 122. For example, the velocity control device 120 can repeatedly, periodically, at timed intervals, based on an alert, based on activity, for example, receipt of data by the network interface 221, in real-time, any other timing, or any combination thereof monitor for the receipt of additional data associated with the one or more parameters. As an example, the velocity control device 120 can transition to an idle state until additional data is received.

At step S406, the velocity control device 120 can receive data associated with the one or more parameters, for example as discussed with respect to FIG. 2, from one or more sources. The one or more sources can comprise one or more sensing devices 125 (that can be any of within, part of, connected to, remote from, or otherwise in communication with the velocity control device 120, or any combination thereof), a monitoring system 180, or both. In one or more embodiments, the received data is utilized to determine one or more parameters 250. For example, a combination of data received from any one or more sources can be utilized to determine one or more parameters 250. In one or more embodiments, the data received is one or more parameters 250.

At step S408, the velocity control device 120 obtains a current or first velocity of the transportation system 122 based on at least one of the one or more parameters. The obtaining the current of first velocity of the transportation system 122 can comprise the velocity control device 120, the monitoring system 180, or both determining the current or first velocity. For example, the velocity control device 120, the monitoring system 180, or both can determine a velocity based on data from any of the one or more sensing devices 125, the monitoring system 180, or both. As an example, the velocity control device 120 can utilize any of GPS data 260 from a GPS device 210, a GPS system 350, or both, acceleration data 280 from one or more accelerometers 220, geographical data 290 from a compass 230, topography data 270 from a topographic mapping system 360, any other data associated with the velocity control device 120, the transportation system 122 or both, or any combination thereof. When the current or first velocity is determined by the monitoring system 180, the velocity control device 120 receives the current or first velocity from the monitoring system 180.

At step S410, the velocity control device 120 obtains a first or current acceleration associated with the transportation system 122 based on at least one of the one or more parameters 250, for example, as discussed with reference to FIG. 3. Obtaining the first or current acceleration can comprise determining the first acceleration based on at least one of the one or more parameters 250 by the velocity control device 120, the monitoring system 180, or both. In this way, the velocity control device 120 can anticipate an acceleration. For example, fuel consumption may be required to be altered based on one or more parameters that prevents acceleration or the maintenance of a current velocity. For example, the fuel consumption can be increased to anticipate the required acceleration to traverse uphill and decreased to anticipate the required acceleration (for example, a deceleration) to traverse downhill.

At step S412, the velocity control device 120 obtains or determines a projected or second acceleration associated with the transportation system 122, for example, to anticipate a required acceleration. The obtaining or determining the projected or second acceleration can comprise the velocity control device 120, the monitoring system 180 or both determining the projected or second acceleration that is an increase or decrease from the first acceleration obtained at step S410 based on additional one or more parameters 250, based on one or more velocity targets (as discussed with reference to FIG. 3), or any combination thereof. The additional one or more parameters 250 can be based on additional data associated with the additional one or more parameters 250 from the one or more sources similar to or the same as discussed with reference to step S406. When the monitoring system 180 determines projected or second acceleration, the velocity control device 120 receives the projected or second acceleration from the monitoring system 180.

At step S414, the velocity control device 120 causes the transportation system 122 to adjust one or more operation settings so as to maintain a velocity of the first transportation system 122. For example, the one or more operation settings can comprise any of the current acceleration, the projected or second acceleration, a cruise control setting, a fuel intake system setting, one or more sensor settings (such as frequency of receiving data from the one or more sensors, adjusting one or more thresholds associated with any of the one or more sensors, etc.), any other setting associated with acceleration of the transportation system 122, or any combination thereof.

At step S416, the velocity control device 120 updates a display device 150 of the transportation system 122 based on the second or projected acceleration. The display device 150 can provide or include a graphical user interface (GUI) that includes information associated with any of a first or current velocity, a second or projected velocity, a first or current acceleration, a second or projected acceleration, a location based on GPS data, a route, the one or more parameters, the additional one or more parameters, connectivity data associated with any one or more connections 11, 13 and/or 15, any other data, or any combination thereof. Updating the display device 150 can comprise the velocity control device 120, the monitoring system 180 or both sending a notification to the display device 150 to notify the user of any of information associated with the transportation system 122 (for example, any of data, one or more parameters, determinations, any other information, or any combination thereof). The notification can comprise a change in the information, an alert as to the information based on a comparison to one or more corresponding thresholds, or any combination thereof.

According to one or more example embodiments of inventive concepts disclosed herein, there are provided novel solutions for monitoring, tracking, mapping and providing a velocity control device of a velocity control system and/or velocity control device for maintaining or adjusting an acceleration associated with a transportation system so as to provide autonomous and/or automatic control of velocity of the transportation system. The novel solutions according to example embodiments of inventive concepts disclosed herein provide features that improve the operation of a transportation system so that a velocity of the transportation system is maintained within one or more velocity targets. In this way, the user experience is enhanced and resources are conserved (for example, fuel consumption is improved, time of travel is predictable as the transportation system can maintain a velocity that is at or about a constant, etc.).

Each of the elements of the present invention may be configured by implementing dedicated hardware or a software program on a memory controlling a processor to perform the functions of any of the components or combinations thereof. Any of the components may be implemented as a CPU or other processor reading and executing a software program from a recording medium such as a hard disk or a semiconductor memory, for example. The processes disclosed above constitute examples of algorithms that can be affected by software, applications (apps, or mobile apps), or computer programs. The software, applications, computer programs or algorithms can be stored on a non-transitory computer-readable medium for instructing a computer, such as a processor in an electronic apparatus, to execute the methods or algorithms described herein and shown in the drawing figures. The software and computer programs, which can also be referred to as programs, applications, components, or code, include machine instructions for a programmable processor, and can be implemented in a high-level procedural language, an object-oriented programming language, a functional programming language, a logical programming language, or an assembly language or machine language.

The term “non-transitory computer-readable medium” refers to any computer program product, apparatus or device, such as a magnetic disk, optical disk, solid-state storage device (SSD), memory, and programmable logic devices (PLDs), used to provide machine instructions or data to a programmable data processor, including a computer-readable medium that receives machine instructions as a computer-readable signal. By way of example, a computer-readable medium can comprise DRAM, RAM, ROM, EEPROM, CD-ROM or other optical disk storage, magnetic disk storage or other magnetic storage devices, or any other medium that can be used to carry or store desired computer-readable program code in the form of instructions or data structures and that can be accessed by a general-purpose or special-purpose computer, or a general-purpose or special-purpose processor. Disk or disc, as used herein, includes compact disc (CD), laser disc, optical disc, digital versatile disc (DVD), floppy disk and Blu-ray disc. Combinations of the above are also included within the scope of computer-readable media.

The word “comprise” or a derivative thereof, when used in a claim, is used in a nonexclusive sense that is not intended to exclude the presence of other elements or steps in a claimed structure or method. As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise. Use of the phrases “capable of,” “configured to,” or “operable to” in one or more embodiments refers to some apparatus, logic, hardware, and/or element designed in such a way to enable use thereof in a specified manner.

While the principles of the inventive concepts have been described above in connection with specific devices, apparatuses, systems, algorithms, programs and/or methods, it is to be clearly understood that this description is made only by way of example and not as limitation. The above description illustrates various example embodiments along with examples of how aspects of particular embodiments may be implemented and are presented to illustrate the flexibility and advantages of particular embodiments as defined by the following claims, and should not be deemed to be the only embodiments. One of ordinary skill in the art will appreciate that based on the above disclosure and the following claims, other arrangements, embodiments, implementations and equivalents may be employed without departing from the scope hereof as defined by the claims. It is contemplated that the implementation of the components and functions of the present disclosure can be done with any newly arising technology that may replace any of the above-implemented technologies. Accordingly, the specification and figures are to be regarded in an illustrative rather than a restrictive sense, and all such modifications are intended to be included within the scope of the present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

What we claim is:

1. A velocity control device of a transportation system comprising:
a memory storing one or more computer-readable instructions; and
a processor configured to execute the one or more computer-readable instructions to:
monitor one or more parameters associated with the transportation system;
receive data associated with the one or more parameters from one or more sources;
obtain a current velocity of the transportation system based on at least one of the one or more parameters;
obtain a current acceleration associated with the transportation system based on at least one of the one or more parameters;
obtain a projected acceleration associated with the transportation system based on additional one or more parameters; and
cause the transportation system to adjust the first acceleration to the second acceleration.

2. The velocity control device of claim 1, wherein the projected acceleration is further based on one or more velocity targets.

3. The velocity control device of claim 1, wherein the projected acceleration is an increase over the current acceleration.

4. The velocity control device of claim 1, wherein the processor is further configured to execute one or more instructions to:
cause the transportation system to alter fuel consumption to adjust to the projected acceleration.

5. The velocity control device of claim 1, wherein the one or more sources comprise any of an accelerometer, a compass, a global positioning system device.

6. The velocity control device of claim 1, wherein the one or more parameters comprise any of a global position system data, a topography data, an acceleration data, a geographical data or any combination thereof.

7. The velocity control device of claim 1, wherein the processor is further configured to execute one or more instructions to:
update a display device of the transportation system based on the projected acceleration.

8. A method of a velocity control device of a transportation system, the method comprising:
monitoring one or more parameters associated with the transportation system;
receiving data associated with the one or more parameters from one or more sources;
obtaining a current velocity of the transportation system based on at least one of the one or more parameters;
obtaining a current acceleration associated with the transportation system based on at least one of the one or more parameters;
obtaining a projected acceleration associated with the transportation system based on additional one or more parameters; and
causing the transportation system to adjust the first acceleration to the second acceleration.

9. The method of claim 8, wherein the projected acceleration is further based on one or more velocity targets.

10. The method of claim 8, wherein the projected acceleration is an increase over the current acceleration.

11. The method of claim 8, further comprising:
causing the transportation system to alter fuel consumption to adjust to the projected acceleration.

12. The method of claim 8, wherein the one or more sources comprise any of an accelerometer, a compass, a global positioning system device.

13. The method of claim 8, wherein the one or more parameters comprise any of a global position system data, a topography data, an acceleration data, a geographical data or any combination thereof.

14. The method of claim 8, further comprising:
updating a display device of the transportation system based on the projected acceleration.

15. A non-transitory computer-readable medium of a velocity control device of a transportation system storing one or more instructions which, when executed by a processor of the velocity control device, cause the velocity control device to perform one or more operations comprising:
monitoring one or more parameters associated with the transportation system;
receiving data associated with the one or more parameters from one or more sources;
obtaining a current velocity of the transportation system based on at least one of the one or more parameters;
obtaining a current acceleration associated with the transportation system based on at least one of the one or more parameters;
obtaining a projected acceleration associated with the transportation system based on additional one or more parameters; and
causing the transportation system to adjust the first acceleration to the second acceleration.

16. The non-transitory computer-readable medium of claim 15, wherein the projected acceleration is further based on one or more velocity targets, the projected acceleration is an increase over the current acceleration, or both.

17. The non-transitory computer-readable medium of claim 15, wherein the one or more instructions when executed by the processor further cause the velocity control device to perform one or more further operations comprising:
causing the transportation system to alter fuel consumption to adjust to the projected acceleration

18. The non-transitory computer-readable medium of claim 15, wherein the one or more sources comprise any of an accelerometer, a compass, a global positioning system device.

19. The non-transitory computer-readable medium of claim 15, wherein the one or more parameters comprise any of a global position system data, a topography data, an acceleration data, a geographical data or any combination thereof.

20. The non-transitory computer-readable medium of claim 15, wherein the one or more instructions when executed by the processor further cause the velocity control device to perform one or more further operations comprising:
updating a display device of the transportation system based on the projected acceleration.
